(19) United States
(12) Patent Application Publication
(10) Pub. No.: US 2008/0010426 A1
(43) Pub. Date: Jan. 10, 2008

(54) Processor system and processing method for operating system program in processor system

(75) Inventors: Tsukasa Yamamoto, Kanagawa (JP); Hitoshi Suzuki, Kanagawa (JP); Rika Ono, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 11/822,235

(22) Filed: Jul. 3, 2007

(30) Foreign Application Priority Data
Jul. 5, 2006 (JP) 185087/2006

(51) Int. Cl. G06F 12/14

(52) U.S. Cl. 711/163

(57) ABSTRACT

A processor system including a CPU core, a functional unit connected to the CPU core, and a plurality of register banks each having at least one system register storing at least one of control information and operation status of at least one of the CPU core and the functional unit therein. Furthermore, the register banks comprise a user bank and a non-user bank, an access to the user bank made by an application program is allowed, and an access to the non-user bank made by the application program is prohibited.

### BACKGROUND OF THE INVENTION

1. Field of the Invention

The present invention relates to a processor system provided with an access control mechanism for system registers each storing control information or the like on a functional unit therein.

2. Description of Related Art

Processor systems, which are embedded in transport machineries such as automobiles and airplanes or in communications equipment such as cellular phones and switching systems, and which control the machineries and equipment, are called embedded systems. In general, such an embedded system is provided with a multiprogramming environment in order to make an improvement in processing time and in productivity of a program by employing a development scheme using software components, to secure real-time-ness and to achieve the equivalent. The multiprogramming environment means an environment in which multiple application programs are executed as if they are executed in parallel by periodically switching the multiple application programs from one to another or by switching a program to another to be executed in accordance with the occurrence of a certain event. Such multiprogramming environment is implemented by use of a central processing unit (CPU) and an operating system program (hereinafter, termed as an OS), which is responsible for scheduling application programs to be executed by the CPU.

A processor system such as the aforementioned embedded system has a configuration in which various functional units are linked to a CPU core. A schematic configuration of a conventional processor system is shown in FIG. 13.

A CPU core is a processing unit, which fetches and executes instructions. The CPU core includes an instruction fetch unit, an integer arithmetic unit, which decodes and executes the fetched instructions, a general-purpose register file and an interface or the like for functional units to be described later. Here, a general-purpose register file is a group of a plurality of general-purpose registers. A general-purpose register is a register that can be used for a general purpose by an application program, and is used as an accumulator for temporarily retaining an operand or an arithmetic result of the integer arithmetic unit or the like, or as an address register for designating an address when accessing to a memory.

Functional units are connected to a CPU core, and provide various functions to the CPU core. Specifically, functional units include: a co-processor such as a floating-point arithmetic unit (FPU) and a multiplication accumulation calculation (MAC) unit; a unit, such as a memory protection unit (MPU) and a debug unit, for providing a function closely linked to the CPU core; and peripheral devices such as a serial interface, a timer and a programmable counter.

A system register group is a set of system registers used for specific applications such as retention of various statuses of the CPU core, a functional unit and a program to be executed by the CPU core, as well as retention of control information on a CPU core and a functional unit for setting the CPU core and the functional unit to be operated in a specific operation mode. Specific examples of the system registers include: 1. a program status word (PSW) register for retaining the status of a program to be executed by a CPU core; 2. a status register indicating an occurrence of an overflow, an underflow, a zero division or the like in an integer arithmetic unit or an FPU; and 3. a control register used for reading out an operation mode of a CPU core, a refresh rate of a DRAM, an SDRAM or the like, and an operation setting or an operation status for a functional unit such as an FPU, a memory protection unit, a debug unit, a memory controller, an interrupt controller, a serial communications port, a timer and a programmable counter.

As mentioned above, various pieces of information are stored in the system registers used for obtaining the control information or operation statuses of the CPU core and functional units. Accordingly, among the system registers, there exist a system register to which an access made by an application program should be allowed, and also a system register to which an access made by an application program should be prohibited. However, since conventional processor systems, particularly, embedded systems are often used for the purpose of executing a certain type of application program, the processor systems are not provided with a mechanism of newly adding an application program in a flexible manner. For this reason, it has not been considered important to provide the processor systems with a mechanism to restrict an access made by an application program to system registers, that is, a mechanism to protect a system register from an application program.

Recently, there is introduced an embedded system configured to execute an application program the reliability of which is not guaranteed, however. Such an embedded system includes a cellular phone capable of downloading and executing a new application program or the like. In such a processor system, there is a risk that a system register to be protected from an application program is accessed by an application program the reliability of which is not guaranteed.

As described above, we have now discovered that there is a problem in conventional processor systems that the protection of the system registers is not sufficient since there exist a system register to which an access made by an application program should be allowed, and also a system register to which an access made by an application program should be prohibited.

It should be noted that Japanese Unexamined Patent Application Publication No. Hei 5-165631 discloses a microcomputer including control registers provided to a plurality of register banks, respectively. In this microcomputer, when any one of the plurality of register banks is to be enabled, the control register included in the register bank to be enabled is accessed first. Specifically, the register banks are switched from one to another by regarding an access to the control register as a trigger. However, Japanese Unexamined Patent Application Publication No. Hei 5-165631 does not disclose anything about a mechanism to protect system registers from an application program.

Furthermore, an ARM processor employs a register bank configuration for 16-bit general-purpose registers, for example. In this configuration, one of the register banks can be used by application programs while other register banks can be used only by a program at a privilege level. For example, a general-purpose register that can be accessed only by an interrupt handler program is provided in order to avoid the process of saving and restoring a register when an interrupt occurs. Although the ARM processor includes architecture using the register bank configuration for the general-purpose registers as described above, a mechanism to protect system registers from an application program by the register bank configuration is not disclosed in the ARM architecture.

### SUMMARY

The present invention seeks to solve one or more of the above problems, or to improve upon those problems at least in part.

In one embodiment, a processor system includes a CPU core, a functional unit connected to the CPU core, and a plurality of register banks each having at least one system register storing at least one of control information and an operation status of at least one of the CPU core and the functional unit therein. Furthermore, the register banks comprise a first register bank that is a user bank to which an access made by an application program is allowed, and a second register bank that is non-user bank to which an access made by the application program is prohibited.

Under such a configuration, a system register to which an access to be made by an application program is allowed, and a system register to which an access to be made by an application program is prohibited are separated into different banks. Accordingly, an access request made by an application program can be restricted in unit of a bank. Thereby, an access to a system register made by an application program in an unauthorized manner can be prevented, and it is possible to protect a system register to which an access made by an application program should be prohibited.

In another embodiment, a method is a processing method of an operating system program for a processor system including a CPU core, a functional unit connected to the CPU core, and a plurality of register banks each having at least one system register storing at least one of control information and an operation status of at least one of the CPU core and the functional unit therein. Specifically, a privilege level of a program executed by the CPU core is determined first. Next, in a case where the program executed by the CPU core is an application program of a non-privilege level, a user bank previously assigned to be a target that can be accessed by an application program is selected among the plurality of register banks. Subsequently, the execution of the application program is started without providing an authority to change the selected register bank to another with the application program.

By use of such a method, an access request made by an application program to a system register can be restricted in unit of a bank. Thereby, an access to a system register made by an application program in an unauthorized manner can be prevented, and it is possible to protect a system register to which an access made by an application program should be prohibited.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a configuration diagram of a processor system according to Embodiment 1 of the invention.

FIG. 2 is a diagram showing an example of mapping to a user bank in the processor system according to Embodiment 1 of the invention.

FIG. 3 is a flowchart showing an operation of the processor system according to Embodiment 1 of the invention.

FIG. 4 is a diagram for explaining the effects of the processor system according to Embodiment 1 of the invention.

FIG. 5 is a configuration diagram of a processor system according to Embodiment 2 of the invention.

FIG. 6 is a configuration diagram of a processor system according to Embodiment 3 of the invention.

FIG. 7 is a flowchart showing an operation of the processor system according to Embodiment 3 of the invention.

FIG. 8 is a diagram showing another configuration example of the processor system according to Embodiment 3 of the invention.

FIG. 9 is a configuration diagram of a processor system according to Embodiment 4 of the invention.

FIG. 10 is a diagram showing a system register bank included in the processor system according to Embodiment 4 of the invention.

FIG. 11 is a flowchart showing an operation of the processor system according Embodiment 4 of the invention.

FIGS. 12A and 12B are diagrams each provided for explaining effects of the processor system according to Embodiment 4 of the invention.

FIG. 13 is a diagram showing a schematic configuration of a conventional processor system.

### DETAILED DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes. Throughout the drawings, the identical elements are denoted by the identical reference numerals, and the overlapped descriptions thereof are omitted herein as appropriate for the purpose of clarification of the descriptions.

### Embodiment 1 of the Invention

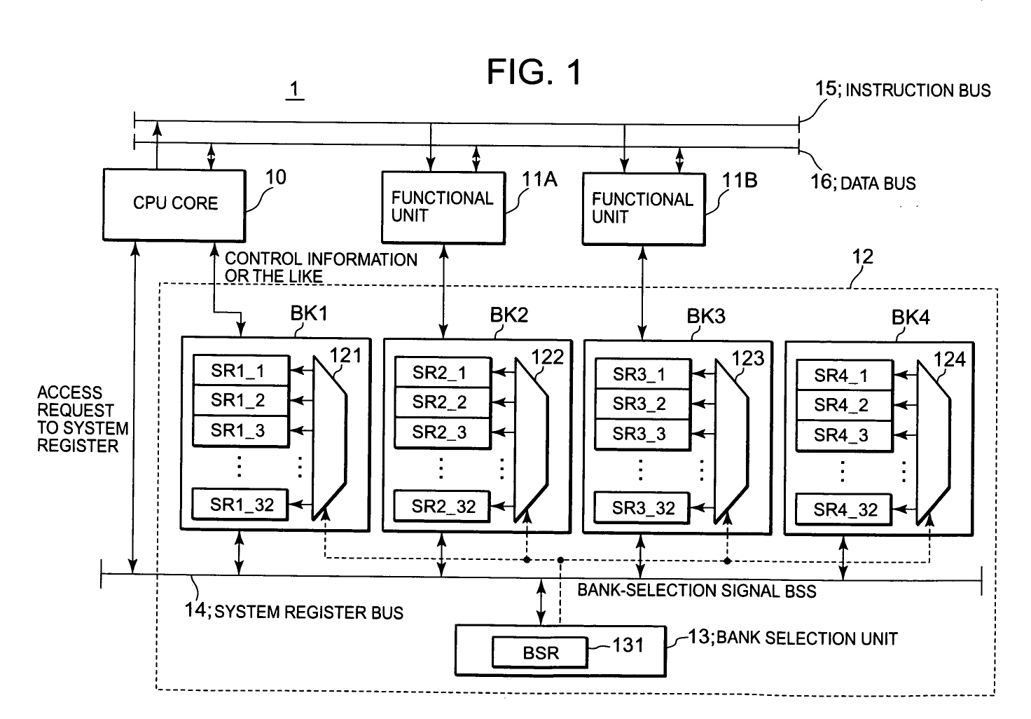

A configuration of a processor system 1 according to the present embodiment is shown in FIG. 1. To being with, constitutional elements included in the processor system 1 will be described with reference to FIG. 1. In FIG. 1, a processor core 10 is a processing unit configured to fetch and decode instructions, and then to execute processing according to the instructions such as arithmetic processing including an arithmetic operation, a logical operation and the like; an issuance of an instruction to functional units; and an access to system registers included in a system register bank 12 to be described later.

Functional units 11A and 11B are connected to the CPU core 10 and provide various functions to the CPU core 10. As described above, a functional unit is a co-processor such as an FPU, a memory protection unit (MPU) and a debug unit.

The system register bank 12 is formed of a plurality of banks obtained by separating a set of system registers. Each of the banks includes one or more registers. FIG. 1 shows a configuration in which the system register bank 12 is provided with four banks BK1 to BK4, and in which each of the banks includes 32 system registers (SR_1 . . . SR1_32, SR2_1 . . . SR2_32, SR3_1 . . . SR3_32, SR4_1 . . . SR4_32). In each of the system registers, various statuses related to a CPU core, functional units and a program to be executed by the CPU core are retained. Moreover, in each of the system registers, control information on the CPU core and the functional units for setting the CPU core and the functional units to be operated in a specific operation mode is retained as well.

A bank selection unit 13 outputs a bank selection signal BSS indicating a bank that is currently selected among the banks BK1 to BK4. Specifically, the bank selection unit 13 is provided with a bank selection register (BSR) 131 in which identification information on the bank currently selected is to be stored, and then the identification information stored in the bank selection register 131 is outputted by a bank selection signal BSS. Incidentally, although it is to be described later in detail, the processor system 1 restricts a bank executed by the CPU core 10 to be a specific bank, the bank capable of being accessed by an application program. For this reason, a program of a privilege level, namely, an OS is allowed to perform a writing operation to the bank selection register 131. Moreover, a writing operation to the bank selection register 131 according to a request issued by an application program, that is, a non-privilege program is prohibited.

Decoders 121 to 124 input an access request to system registers, the request outputted from the CPU core 10, and the bank selection signal BBS outputted from the bank selection unit 13. Furthermore, the decoders 121 to 124 select a predetermined system register according to a combination of a register number of an access destination included in the access request and the bank identification information included in the bank selection signal BBS. For example, in a case where the identification information on the bank BK4 is set in the bank selection register 131, and also where the access request to a system register, the request being issued by the CPU core 10, indicates a register number “1,” a register SR4_1 is selected by the decoder 124 as the access destination.

A system register bus 14 is a bus through which an access request issued by the CPU core 10 is transmitted to the system register bank 12. An instruction bus 15 is an instruction bus used for the transmission of an instruction outputted from the CPU core 10 to the functional units 11A and 11B. Furthermore, a data bus 16 is a bus used for the transmission of data between the CPU core 10 and the functional units 11A and 11B.

Hereinafter, a mechanism to restrict an access made by an application program to system registers will be described in detail. The processor system 1 has a feature that the system processor 1 defines at least one bank among the banks included in the system register bank 12 as the bank that can be accessed by an application program, and that the defined bank is selected when the CPU core 10 executes an application program. Hereinafter, the bank to which an access made by an application program is allowed is termed as a “user bank.”

In the configuration of the processor system 1 shown in FIG. 1, the bank BK4 is defined as the user bank. It should be noted that the bank BK1 is a set of system registers for retaining status and control information on the CPU core 10 and on a program to be executed by the CPU core 10. The bank BK2 is a set of system registers for retaining status and control information on the functional unit 11A. Furthermore, the bank BK3 is a set of system registers for retaining status and control information on the functional unit 11B. Among the plurality of system registers included in the other banks BK1 to BK3, the system registers required for executing an application program are associated with system registers of the bank BK4. Hereinafter, associating the system registers of the user bank (BK4) with the system registers of the other banks (BK1 to BK3) is termed as “mapping.”

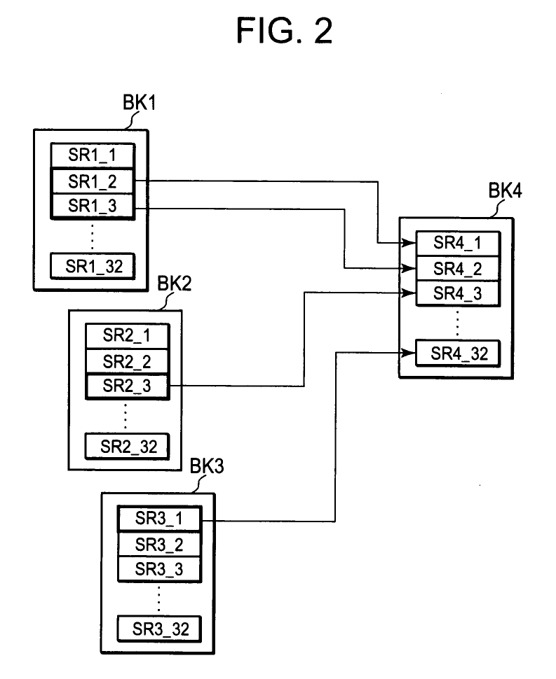

An example of mapping is shown in FIG. 2. In FIG. 2, a register SR1_2 of the bank BK1 is mapped with the register SR4_1 of the user bank BK4, and a register SR1_3 of the bank BK1 is mapped with a register SR4_2 of the user bank BK4. Moreover, a register SR2_3 of the bank BK2 is mapped with a register SR4_3 of the user bank BK4, and a register SR3_1 of the bank BK3 is mapped with a register SR4_32 of the user bank BK4. It should be noted that, not only a single system register is mapped with a single register as the user bank BK4 as shown in FIG. 2, but also a part of the bit of a single system register may be mapped with a system register as the user bank BK4. Moreover, bits included in a plurality of system registers may be mapped with a single register as the user bank BK4.

The mapping as shown in FIG. 2 can be realized by decode logics of the decoders 121 to 124. Specifically, in a case where a writing operation is to be performed on a system register, a writing operation to the system register as the user bank, which is associated with the system register by the mapping, may be performed simultaneously in accordance with the writing request to the system register. For example, in a case where a writing request is issued for a register having a register number “1” when the bank BK4 is selected, in accordance with the writing request, the decode logics of the decoders 121 to 124 may be determined such that the decoder 124 selects the register SR4_1, and that the decoder 121 selects the register SR1_2.

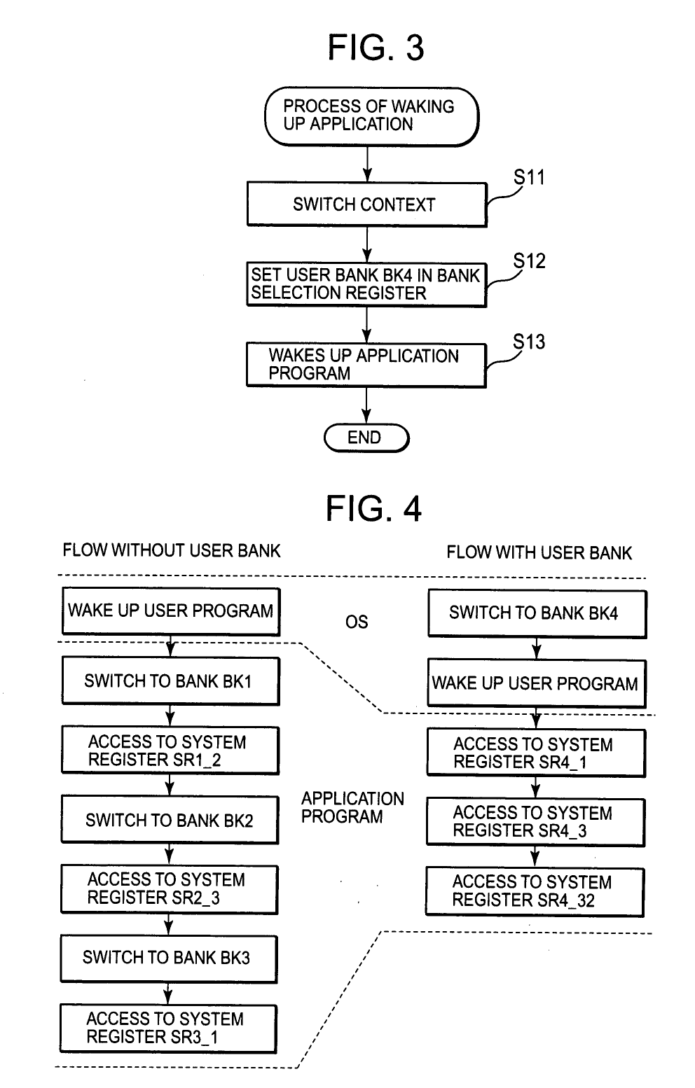

Next, an operation of the processor system 1 when the user bank BK4 is selected will be described. The processor system 1 is configured in such a manner that a register bank that can be accessed by an application program is restricted to be a certain register bank by the bank selection register 131 and the decoders 121 to 124. Then, the system register that can be accessed by an application program is restricted to be a certain register bank when the OS selects the user bank at the time of executing an application program. Specifically, as shown in a flowchart of FIG. 3, when an OS wakes up an application program, the OS starts the execution of the application program in a state where the user bank BK4 is selected. In step S11, for restoring the context of the application program that is to be started and executed, the OS performs a context switch process. In step S12, the OS sets the identification information on the user bank BK4 in the bank selection register 131. In step S13, the OS wakes up the application program, and the execution of the application program is started.

As described above, the processor system 1 according to the present embodiment separates a set of system registers into a plurality of banks and then sets at least one bank to be a user bank. Moreover, the processor system 1 is that for executing an application program in a state where the user bank is selected. Specifically, the processor system 1 separates a system register to which an access made by an application program is allowed, and a system register to which an access made by an application program is prohibited into different banks. The system processor 1, then, restricts an access request made by an application program to a system register in unit of a bank. Under such a configuration, the banks other than a user bank can be hidden from application programs. Thus, it is possible to securely prevent an unauthorized access to be made by an application program to the system registers.

In addition, it is desirable that a system register to be accessed by a single application program is be mapped with a single user bank. Thereby, the switching of a bank to another becomes unnecessary during the execution of the program, so that the overhead required for the process of the switching of a bank to another can be eliminated. A specific example will be provided with reference to FIG. 4. In the FIG. 4, “FLOW WITHOUT USER BANK” shows a process without designating a user bank when access requests are issued in a sequence of the system registers SR1_2, SR2_3, and SR3_1. On the other hand, In the FIG. 4, “FLOW WITH USER BANK” shows a process of the processor system 1 provided with the user bank BK4. In the case of “FLOW WITHOUT USER BANK”, since each of the three system registers belongs to the different banks, respectively, it is required to execute the process of the switching of a bank for each of the access requests. In such a process, not only the system registers are insufficiently protected from an application program, but also the processing overhead increases since the process of the switching of a bank occurs frequently. In contrast to this case, in the case of “FLOW WITH USER BANK”, the processing overhead can be suppressed since the process of the switching of a bank is not required.

Furthermore, when the system registers to be accessed by a single application are mapped with a single user bank, a developer of the application program can program the application without taking the presence of the banks into consideration. Thus, there is an advantage that the burden of the program development can be reduced.

In addition, although in the processor system 1 according to the present embodiment, the mapping of the system registers in the user bank with the system registers of the other banks is set by the decode logics of the decoders 121 to 124, it is possible to employ a configuration that allows the mapping information to be changed. Thereby, the changing of the mapping of the system registers, that is, the changing of the system registers to be disclosed to the application program can be easily realized without changing the hardware of the processor system 1. As an example of a specific method of realizing such a configuration, by storing mapping information on the system registers in a user bank with the system registers of the other banks in a memory unit (not shown), the decoders 121 to 124 can select a system register in accordance with the mapping information stored in the memory unit. By use of a RAM as the memory unit for storing the mapping information, the mapping can be dynamically changed. Such a configuration is advantageous in an application of a general-purpose processor system or the like, which does not specify an application program.

### Embodiment 2 of the Invention

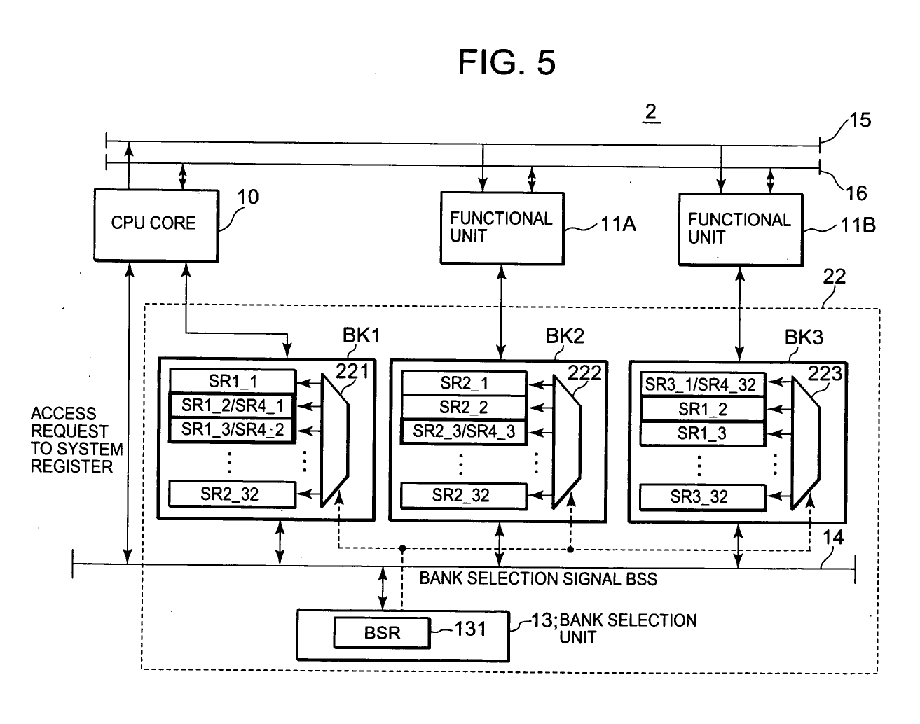

The configuration of a processor system 2 according to the present embodiment is shown in FIG. 5. A feature of the processor system 2 is that the user bank is virtually realized by the decode logics of decoders 221 to 223 without setting a user bank as a physical set of registers independent of other banks. As an example, consider a case where the same mapping relationships as the ones shown in FIG. 2 are to be applied between the virtualized user bank BK4 and the other banks BK1 to BK3. The decoder 221 of the bank BK1 selects the register SR1_1 in a case where there is an access request from the CPU core 10 to a register having the register number “1” in a state where the bank BK1 is selected by the bank selection register 131. On the other hand, in a case where there is an access request from the CPU core 10 to a register having the register number “1” in a state where the user bank BK4 is selected, the register SR1_2 mapped with the virtualized register SR4_1 is selected. Likewise, in a case where there is an access request to a register having the register number “2” in a state where the user bank BK4 is selected by the bank selection register 131, the register SR1_3 mapped with the virtualized register SR4_2 is selected by the decoder 221. Moreover, in a case where there is an access request to a register having the register number “3” in a state where the user bank BK4 is selected, the register SR2_3 corresponding to the virtualized register SR4_3 is selected by the decoder 222.

It should be noted that the operations of such decoders 221 to 223 are the same as those of the decoders 121 to 124 according to Embodiment 1 of the invention, which are described as the method of realizing the mapping shown in FIG. 2. As described above, by employing the configuration in which decoders 221 to 223 select, on the basis of identification information on the bank selected by the OS, for a system register that should correspond to the access request, it is not necessary to provide the user bank BK4 as a register resource physically independent of the other banks. Thus, the user bank can be virtualized. Thereby, the redundancy of a system register bank 22 can be eliminated, and a physical register resource to be allocated as the user bank can be reduced as well.

### Embodiment 3 of the Invention

A processor system 3 according to the present embodiment provides a feature of prohibiting a particular type of access request in accordance with a privilege level assigned to the application program rather than uniformly allowing an access request from an application program to a user bank. It should be noted that a particular type of access request to be described below is a write access request in particular.

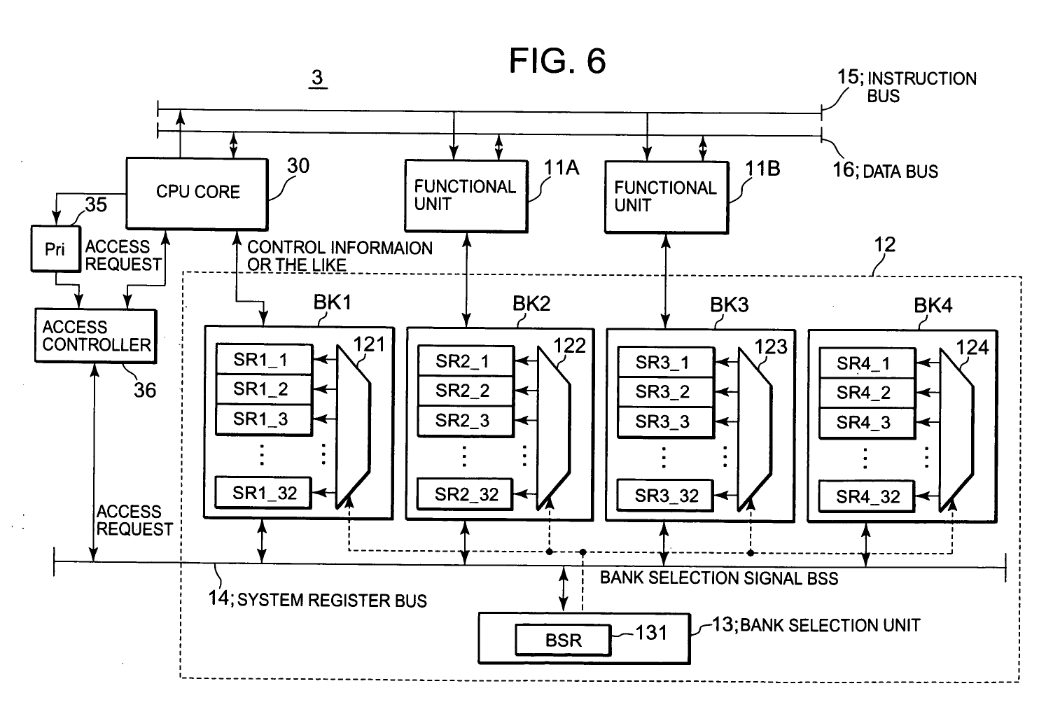

A configuration of the processor system 3 is shown in FIG. 6. The difference between the configuration of the processor system 3 and the processor system 1 of Embodiment 1 is that a privilege bit storing unit 35 and an access controller 36 are provided in the processor system 3. In the privilege bit storing unit 35, a privilege bit indicating whether or not a write access to the system register bank 12 is allowed is stored. Specifically, a privilege bit corresponds to authority information indicating an authority level assigned to an application program, and the privilege bit storing unit 35 corresponds to a unit for storing authority information therein.

For example, a privilege bit may be set by using one bit data, and the value of a privilege level, which indicates that a write access is allowed, may be set to “1.” Moreover, the value of a non-privilege level, which indicates that a write access is prohibited, may be set to “0.” The value stored in the privilege bit storing unit 35 can be rewritten by an OS to be executed by a CPU core 30, but the rewriting of the value by an application program is prohibited.

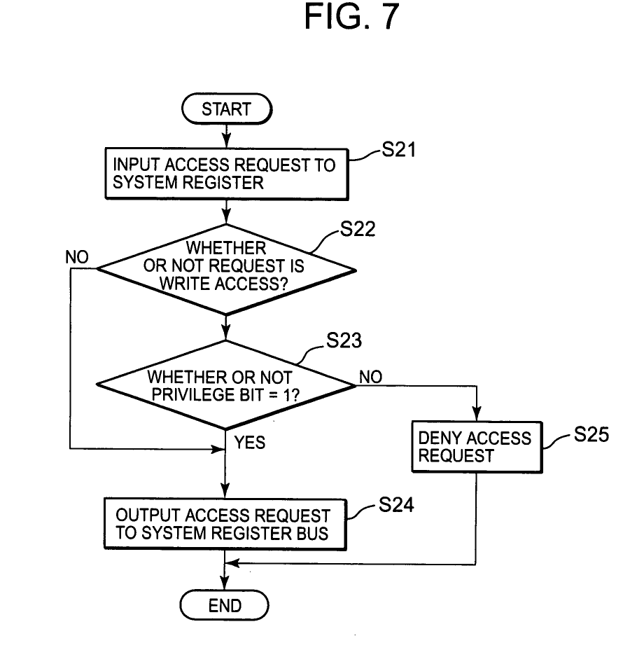

The access controller 36 receives an access request to a system register from the CPU core 30, and when the type of access request is a write access, the access controller 36 outputs the access request to the system register bus 14 only in a case where the value stored in the privilege bit storing unit 35 indicates a privilege level. The process of the access controller 36 is shown in the flowchart in FIG. 7. In step 21, an access request to a system register is inputted from the CPU core 30 to the access controller 36. The access controller 36 outputs the access request to the system bus 14 in a case where the access request inputted is a read access request (step 22 and 24). In a case where the access request inputted in step S21 is a write access request, the access controller 36 refers to the privilege bit storing unit 35, and when the value indicating a privilege level is set, the access controller 36 outputs the inputted write access request to the system register bus 14 (steps 22 to 24). On the other hand, in a case where the value indicating a privilege level is not set in the privilege bit storing unit 35, the access controller 36 denies the inputted write access request (step S25).

In the aforementioned configuration, when an application program is executed, by causing a value indicating a non-privilege level (for example, 0) to be stored in the privilege bit storing unit 35, a read access request made by an application program to a system register is allowed, and a write access request can be prohibited. It should be noted that the aforementioned determination by the access controller 35 whether or not to deny an access may be made in unit of a register included in the user bank BK4.

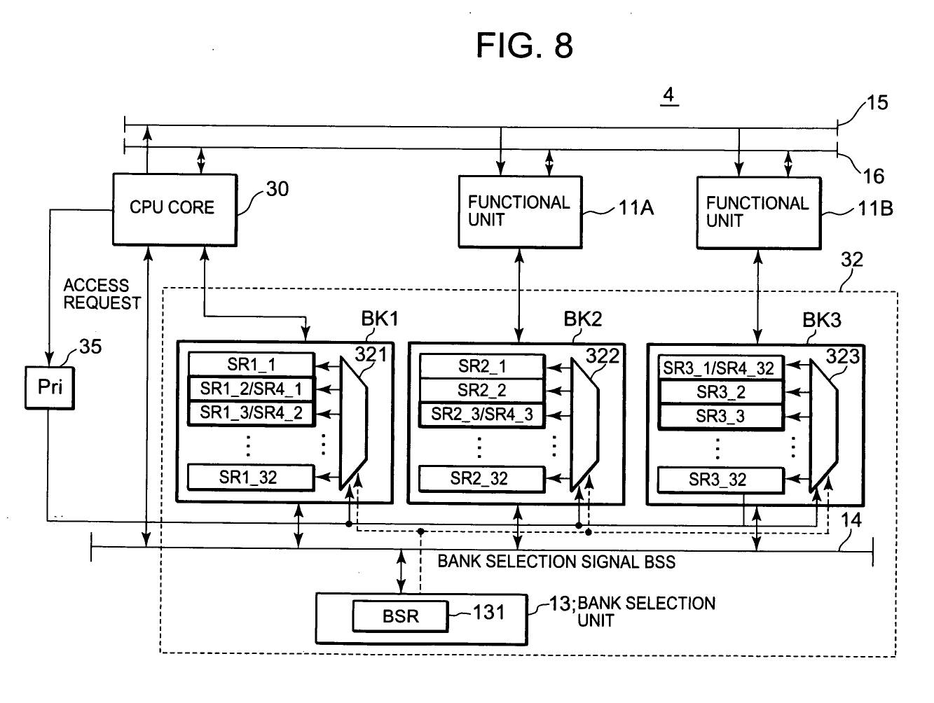

Another configuration example of the processor system 3 according to the present embodiment is shown in FIG. 8. In a processor system 4 of FIG. 8, the functions of the access controller 36 are realized by the decode logics of decoders 321 to 323. Specifically, in this configuration, the decoders 321 to 323 receives a signal indicating the value stored in the privilege bit storing unit 35, and the decoders 321 to 323 decode the access request with reference to the value stored in the privilege bit storing unit 35. Upon receipt of a write access request, the decoders 321 to 323 select a system register only in a case where the privilege bit indicates a privilege level. A write access made by an application program of a non-privilege level to a system register can be prohibited as well in the processor system 4 configured in such a manner.

Moreover, the aforementioned privilege bit storing unit 35 can be realized as a system register. Specifically, since information on the privilege level of an application program to be executed by the CPU core 30 is retained in a system register (PSW register) for storing a status of the program, the information indicating a privilege level of an application program, which is stored in the system register, as a privilege bit can be used in the determination whether or not a write access to the system register is allowed.

### Embodiment 4 of the Invention

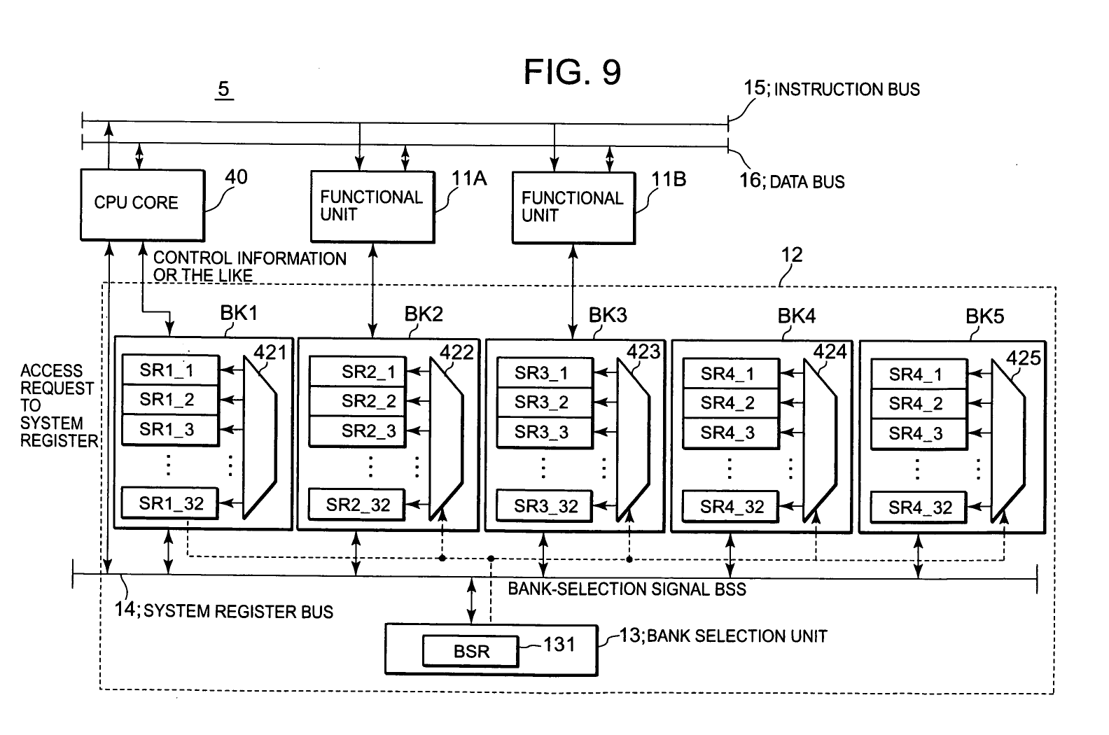

A processor system 5 according to the present embodiment is provided with a plurality of user banks, and provides a feature to select, from the plurality of user banks, in accordance with an application program to be executed by the CPU core, a user bank that can be accessed by the application program. A configuration of the processor system 5 is shown in FIG. 9. The processor system 5 and the processor system 1 according to Embodiment 1 of the invention are different in that a system register bank 42 of the processor system 5 includes two user banks BK4 and BK5.

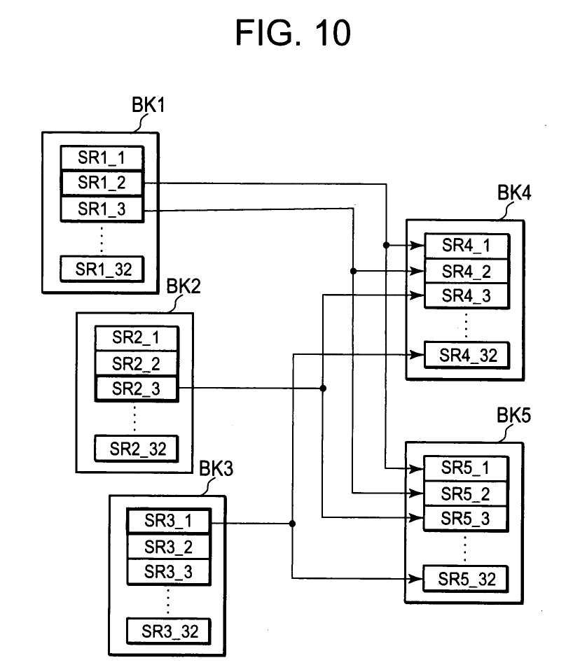

An example of mapping between three banks BK1 to BK3 to which an access made by an application program is prohibited, and two user banks BK4 and BK5 are shown in FIG. 10. FIG. 10 shows a case where the same system registers are mapped with the user banks BK4 and BK5. For example, the register SR1_1 of the bank BK1 is mapped with the system register SR4_1 of the user bank BK4, and the system register SR5_1 of the user bank BK5. It should be noted that the mapping in FIG. 10 is merely an example, and thus a different system register may be assigned to the user banks BK4 and BK5.

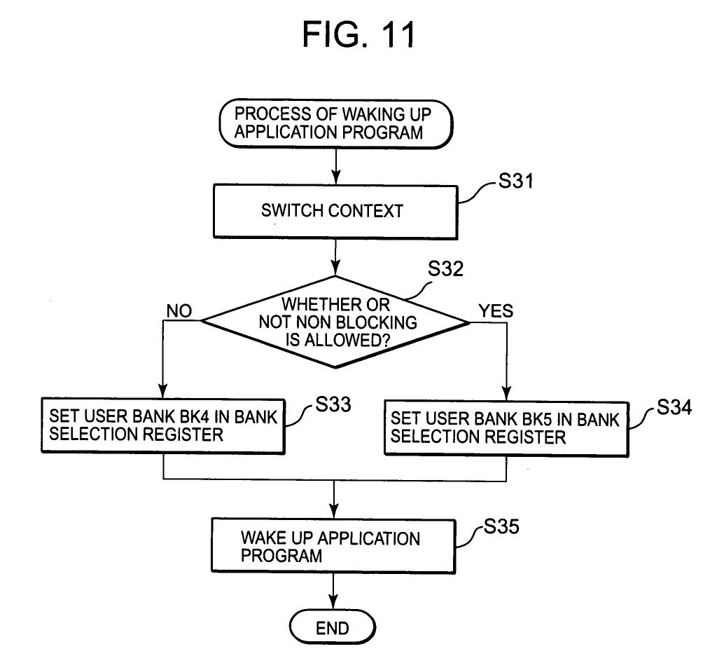

Next, an operation of selecting the user bank BK4 or BK5 in accordance with an application program will be described with reference to the flowchart shown in FIG. 11. FIG. 11 shows a case where an operation system program (OS) to be executed by a CPU core 40 selects the user bank BK4 or BK5 in accordance with the determination whether or not a non-blocking access to be made by an application program to a system register is allowed. Here, the user bank BK4 is set to be a user bank for an application program prohibited from making the non-blocking access, and the user bank BK5 is set to be a user bank for an application program allowed to make the non-blocking access. Specifically, system registers to which a non-blocking access may be allowed are mapped with the user bank BK5.

Firstly, in step S31, the OS performs a context switching process for restoring the context of an application program to be executed. Next, in step S32, the OS determines whether or not the application program to be executed is a program the non-blocking access of which is allowed. In a case where it is determined in step S32 that the application program is the one the non-blocking access of which is not allowed, the identification information on the user bank BK4 is set in the bank selection register 131 (step S33). On the other hand, in a case where it is determined in step S32 that the application program is one the non-blocking access of which is allowed, the identification information on the user bank BK5 is set in the bank selection register 131 (step S34). In step S35, the OS wakes up the application program, and then the execution of the application program is started.

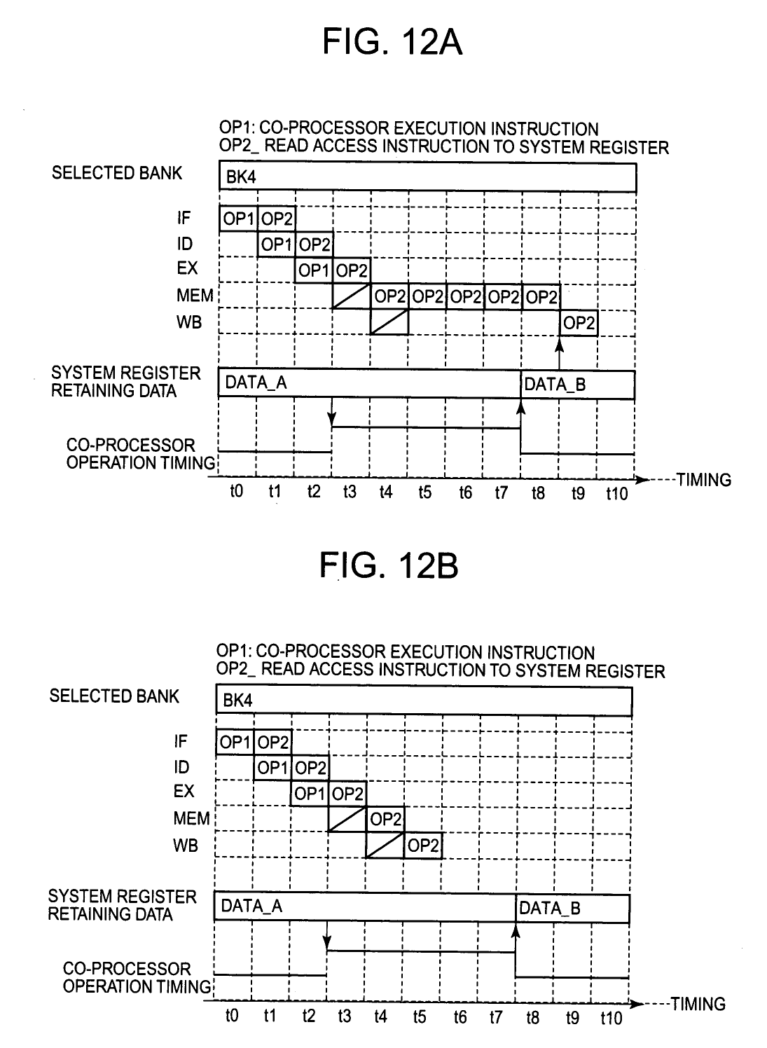

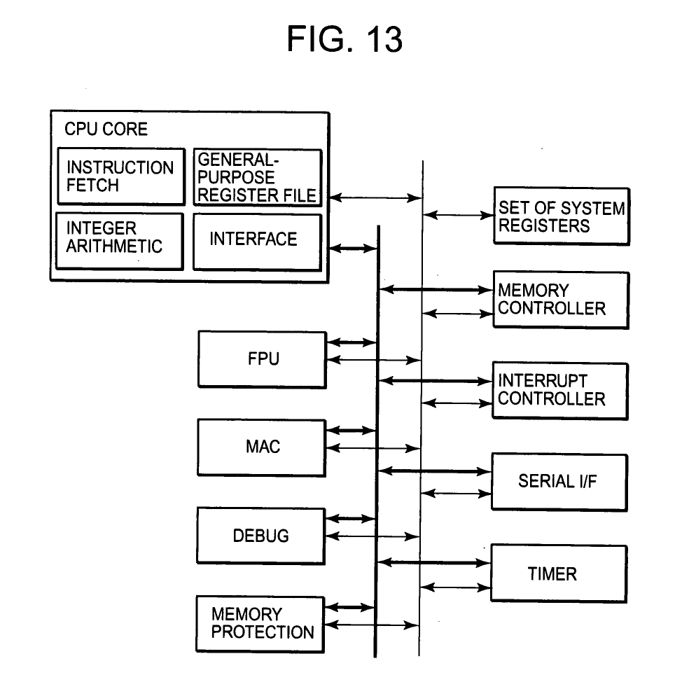

The differences between the cases where a non-blocking access to a system register is allowed, and where a non-blocking access to a system register is not allowed will be described with reference to FIGS. 12A and 12B. The timing charts shown in FIGS. 12A and 12B both assume that any one of the functional units 11A and 11B is a co-processor, and indicate that pipe line processing of the CPU core 40 in a case where an instruction OP1 to be executed by the core processor, and a read access instruction OP2 are executed in a continuous manner. However, FIG. 12A shows the case where a non-blocking access to a system register is prohibited, and FIG. 12B shows the case where a non-blocking access to a system register is allowed.

In FIG. 12A, the user bank BK4 is selected. The user bank BK4 is a user bank for an application program whose non-blocking access is prohibited. In an instruction fetching (IF) stage, an instruction decoding (ID) stage and an instruction execution (EX) stage, the instructions OP1 and OP2 are executed in a continuous manner. However, since an access to a system register by the instruction OP2 is caused to wait until the completion of the execution of the instruction OP1 by the core processor, the pipe line stops for a period of time equivalent to four clock cycles from timings t4 to t7 in a memory access (MEM) stage of the instruction OP2. Accordingly, the acquisition of the value of the system register by the instruction OP2 in a write back (WB) stage is executed at a timing t9 after the completion of the execution of the instruction OP1 by the core processor.

On the other hand, in FIG. 12B, the user bank BK5 is selected. The user bank BK5 is a user bank for an application program whose non-blocking access is allowed. In this case, a read access by the instruction OP2 to a system register is performed without waiting for the completion of the execution of the instruction OP1 by the core processor. For this reason, the acquisition of the stored value of the system register by the instruction OP2 is executed at a timing t5.

As described above, by providing a plurality of user banks, and by selecting a user bank for non-blocking access at the time of executing the application program, a system register not included in the user bank for non-blocking access can be securely protected.

It should be noted that the operation of selecting a user bank to be used in accordance with the determination whether or not a non-blocking access to a system register is allowed is an example only. For example, a plurality of user banks may be mapped with different sets of system registers from one another, and a user bank to be used may be switched to another in accordance with an application program.

### Other Embodiment of the Invention

In aforementioned Embodiments 1 to 4 of the invention, the bank selection unit 13 is independently provided. However, the bank selection register 131 may be mapped with any one of system registers of each of the banks; that is, identification information on banks, which is to be retained in the bank selection register 131, may be retained in the system registers of each of the banks. In this case, the decoders 121 to 124 or the like may decode an access request by use of the identification information on the banks retained in the system registers.

It is apparent that the present invention is not limited to the above embodiments, but may be modified and changed without departing from the scope and spirit of the invention.

What is claimed is:

1. A processor system comprising:
a CPU core;
a functional unit connected to the CPU core; and
a plurality of register banks each having at least one system register storing at least one of control information and an operation status of at least one of the CPU core and the functional unit therein, wherein
said register banks comprise a first register bank that is a user bank to which an access made by an application program is allowed, and a second register bank that is a non-user bank to which an access made by the application program is prohibited.

2. The processor system according to claim 1, wherein an operating system program is capable of accessing all of the register banks.

3. The processor system according to claim 1, wherein the system register included in the user bank is associated with the system register included in the non-user bank, and does not exist as a physical register resource independent of the non-user bank.

4. The processor system according to claim 1, further comprising:
a bank selection unit capable of retaining bank identification information that can be used for uniquely identifying each of the register banks; and
a decoder selecting a system register as an access destination on the basis of the bank identification information and of register designation information included in an access request from the CPU core to the system register.

5. The processor system according to claim 4, wherein the decoder selects the system register included in the non-user bank in both cases where the bank identification information retained in the bank selection unit indicates the non-user bank, and where the bank identification information indicates the user bank.

6. The processor system according to claim 4, wherein the system register included in the user bank is associated, by the decoder, with the system register included in the non-user bank, and the system register included in the user bank does not exist as a physical register resource independent of the non-user bank.

7. The processor system according to claim 4, wherein in accordance with the access request to the system register, the decoder selects the system register included in the user bank and the system register included in the non-user bank when the bank identification information retained in the bank selection unit indicates the user bank.

8. The processor system according to claim 4, wherein a decode logic of the decoder for selecting the system register as the access destination can be changed in accordance with a type of the application program.

9. The processor system according to claim 1, wherein the non-user bank has a plurality of the system registers, and mapping information for constituting the user bank is added to a system register to which an access made by the application program is allowed among the system registers.

10. The processor system according to claim 9, further comprising:
a bank selection unit for retaining bank identification information allowing each of the register banks to be uniquely identified; and
a decoder selecting a system register as an access destination based on the bank identification information, register designation information included in an access request from the CPU core to the system register, and the mapping information.

11. The processor system according to claim 1, further comprising an access controller for restricting an access request made by the application program to the user bank in accordance with an authority level assigned to the application program.

12. The processor system according to claim 1, further comprising a plurality of the user banks,
wherein one of the user banks that can be accessed by the application program is switched to another in accordance with a type of the application program.

13. The processor system according to claim 1, wherein the functional unit is any one of a floating-point arithmetic unit, a multiplication accumulation calculation unit, a memory protection unit for controlling a memory access request issued by the CPU core, a debug unit for collecting performance information on a program executed by the CPU core, a serial interface, a timer and a programmable counter.

14. The processor system according to claim 4, wherein each of the register banks has the decoder.

15. The processor system according to claim 4, wherein the decoder selects the system register further on the basis of mapping information for constituting the user bank stored in a memory unit.

16. A processing method for an operating system program in a processor system, the processor system including a CPU core, a functional unit connected to the CPU core, and a plurality of register banks each having at least one system register storing at least one of control information and an operation status of at least one of the CPU core and the functional unit therein, the method comprising:
determining a privilege level of a program executed by the CPU core;
selecting a user bank previously assigned as a target that can be accessed by an application program among the plurality of register banks when the program executed by the CPU core is an application program of a non-privilege level; and
starting an execution of the application program without providing the application program with an authority to change the register bank that can be accessed to another.

17. The method according to claim 16, which is used when the processor system includes a plurality of user banks, the method further comprising selecting a user bank that can be accessed by the application program, among the plurality of user banks in accordance with a type of the application program.
